(19) United States
(12) Patent Application Publication
(10) Pub. No.: US 2010/0132181 A1
(43) Pub. Date: Jun. 3, 2010

(54) Method of assembly of bathtub enclosure

(76) Inventors: Trevor Sullivan, Franklin, TN (US); James Davidson, Jackson, TN (US); Michael Burrall, Brownsville, TN (US); David Solomon, Franklin, TN (US)

Correspondence Address: Muncy, Geissler, Olds & Lowe, PLLC, 4000 Legato Road, Suite 310, FAIRFAX, VA, 22033, US

(21) Appl. No.: 12/457,340

(22) Filed: Jun. 8, 2009

Related U.S. Application Data
(60) Provisional application No. 61/129,134, filed on Jun. 6, 2008.

(51) Int. Cl. B23P 17/04

(52) U.S. Cl. 29/428

(57) ABSTRACT

An enclosure for a bathtub is constructed at a factory or other location remote from a site where the bathtub is to be permanently installed. The bathtub is placed permanently in the enclosure at the factory or remote location and once placed, the bathtub and enclosure are in condition for use at its permanent site without the necessity of further assembly.

### FIELD OP THE INVENTION

This invention relates to a method of assembly of a bathtub and an enclosure for the bathtub and more particularly to a method of assembly of a bathtub and enclosure at a factory or other location remote from a site where the bathtub is to be permanently installed. Once assembled, the bathtub and enclosure forms a single unit which is in condition for permanent installation without the necessity of further assembly.

### BACKGROUND OF THE INVENTION

Bathtubs after they are manufactured are conventionally packed in corrugated cardboard or plywood crates and are shipped to retailers for sale to the public or to sites where they are to be permanently installed. Enclosures to accommodate the bathtubs are usually constructed by hand by skilled workmen at the site of permanent installation.

After the enclosures are constructed, the bathtubs are positioned in them and are levelled to ensure that they function properly. Modern bathtubs such as whirlpool tubs in particular must be horizontal to ensure that the water which discharges from their underwater jets is aimed properly. Such adjustments require skill and considerable time and, as a result, is a significant component of the overall cost of the bathtub.

We have found that the enclosures for bathtubs can be mass produced at a factory where there is machinery such as power saws, presses and pneumatic staple guns in order to accelerate the process of construction. The cost of constructing enclosures at a factory is considerably less than that at a permanent location of the enclosures where power saws, presses and pneumatic staple guns are seldom available.

Bathtubs can be permanently installed in the enclosures at a factory at the time of construction of the enclosures. Steps can be taken at this time to ensure that the tubs are properly positioned in the enclosures such that the tubs are oriented in a position required to function properly when the enclosures are permanently installed in a bathroom for use

In summary, according to our invention, the enclosure is constructed and a bathtub is permanently installed in the enclosure at a factory. The tub and enclosure form a single unit which can be shipped from a factory and installed in the same form as it was when it left the factory. The only operation needed at the site where the unit is installed is to position the enclosure so that its bottom wall is level. Shims may be used for this purpose where the floor on which the enclosure is to rest is not level. The operation can usually be accomplished in a matter of minutes as opposed to hours where, according to conventional practice, only the bathtub is delivered to the site and the enclosure must be constructed from scratch at the site.

The process of our invention involves, briefly, the following steps carried out at a factory or other location remote from the site when a bathtub is to be permanently located: (1) providing the materials which will form the components of the enclosure. (2) forming from the materials an enclosure having end and side walls and a bottom surface which contacts and exerts the weight of the enclosure and bathtub on a floor or other surface; (3) taking appropriate steps to ensure that the bottom wall is adapted to rest solidly on a level surface and does not to rock; (4) placing the bathtub in the enclosure; and (5) permanently affixing the bathtub to the enclosure such that the bathtub is oriented in a position required to function properly when the bottom wall is level; and (6) shipping the bathtub and enclosure from the factory or other location.

### DESCRIPTION OF THE DRAWINGS

The subject process is described with reference to the accompanying drawings in which:

FIG. 1 sets out the steps in the method of the invention;

FIG. 2 is a perspective view of the enclosure in the course of construction;

FIG. 3 is a perspective view of the enclosure of FIG. 2 in conjunction with a bathtub; and

FIG. 4 is a perspective view of an enclosure and a bathtub positioned in the enclosure.

Like reference characters refer to like parts throughout the description of the drawings.

### DESCRIPTION OF PREFERRED STEPS OF THE METHOD

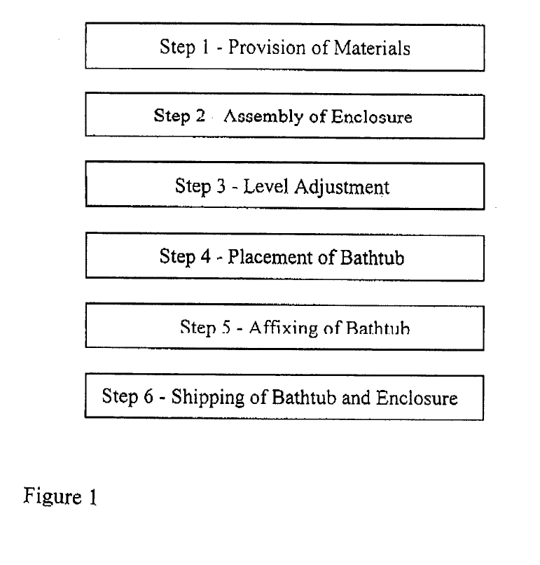

With reference to FIG. 1, the method of the invention involves the following steps which are carried out at a factory or other location remote from the site where the bathtub and enclosure are to be permanently located. Step 1 involves providing the materials which will form the structure of the enclosure. Step 2 involves assembling the material into a structure which will serve as a permanent enclosure for a bathtub. The structure has end and side walls and a bottom surface which contacts and bears the weight of the enclosure and bathtub on a floor or other surface. Step 3 involves taking appropriate steps to ensure that the bottom surface is adapted to rest solidly on a level surface and does not to rock. Step 4 involves placing the bathtub in the enclosure and Step 5 involves permanently affixing the bathtub to the enclosure such that the bathtub is oriented in a position required to function properly when the bottom wall is level. Step 6 involves shipping the enclosure and bathtub of step 5 to its permanent location or to a warehouse, retail outlet or elsewhere for later shipping to its permanent location.

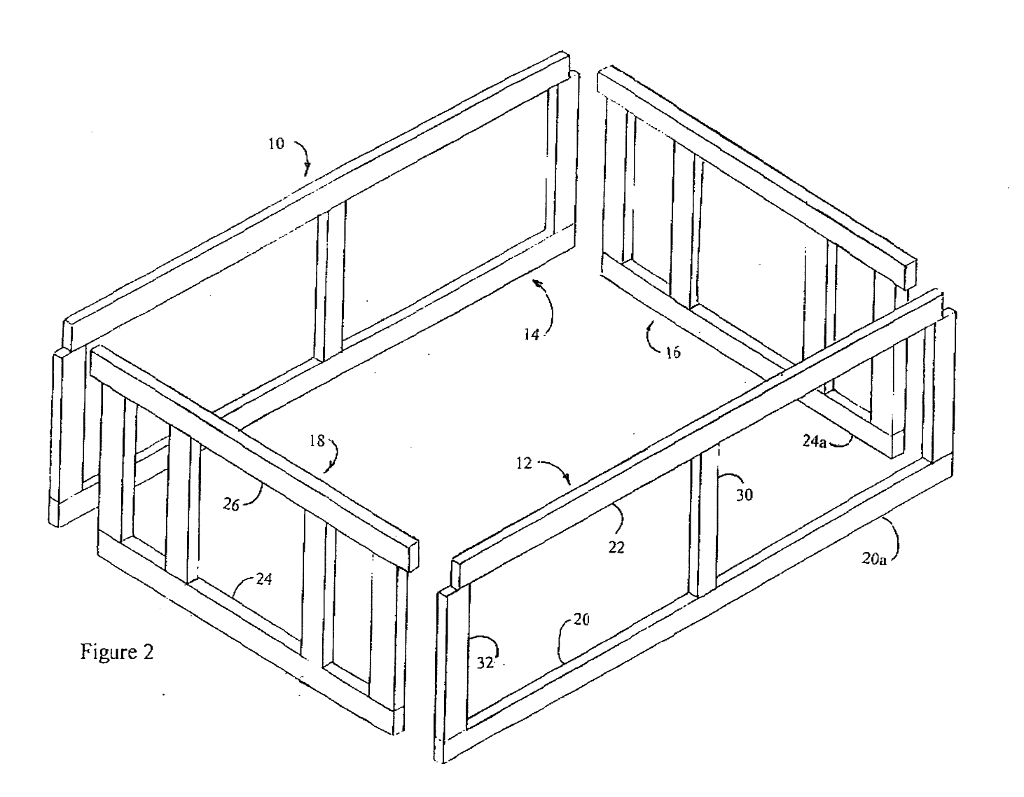

With reference to FIG. 2, the enclosure, generally 10, consists of front and back side walls, generally 12, 14 respectively and end walls, generally 16, 18 respectively, at opposite ends of the structure. Each side wall is made up of a pair of spaced horizontally extending lower and upper stringers 20, 22 respectively. The front and back walls are each made up of pair of spaced lower and upper crosspieces 24, 26, respectively.

The stringers run along the length of the structure while the crosspieces extend the width of the structure at opposite ends. The under or bottom surfaces 20a, 24a, of the lower stringers and cross members, respectively, all lie in the same imaginary plane so that the enclosure, when it rests on a level or horizontal floor rests solidly and does not rock.

The stringers and crosspieces are reinforced by uprights 30 which extend between the lower and upper stringers and the lower and upper crosspieces. There is a vertical column 32 at each corner of the structure.

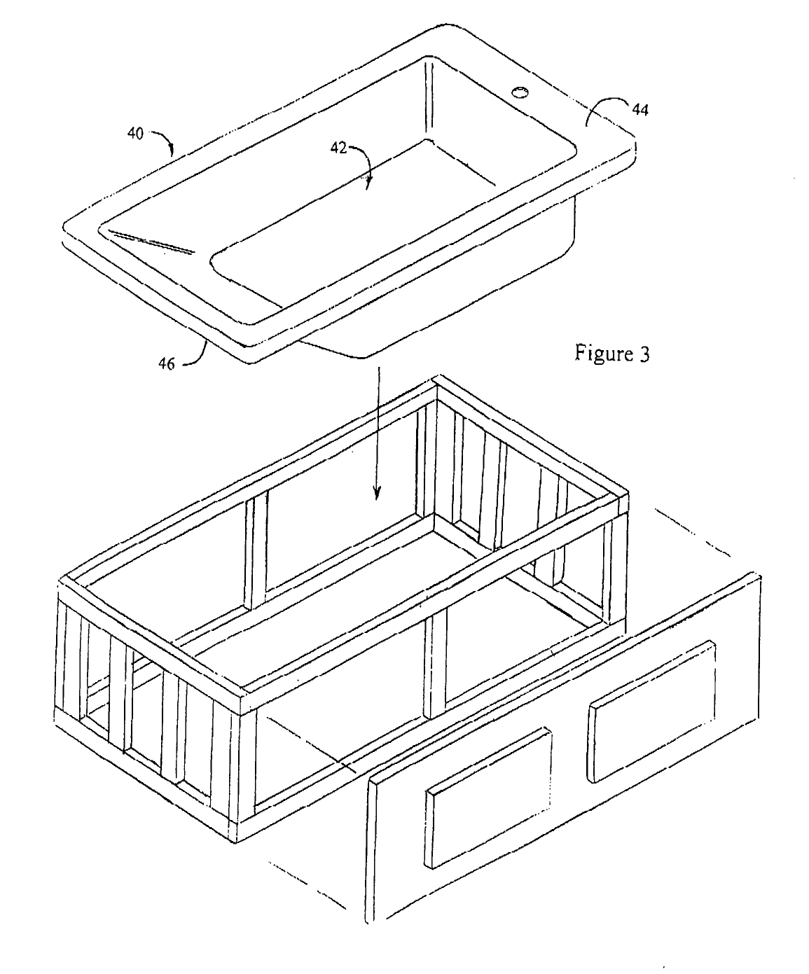

With reference to FIG. 3, the bathtub, generally 40 is of conventional construction and is composed of a downwardly extending central trough, generally 42 and a horizontal upper wall 44. The latter wall extends outwardly from the upper edge of the trough and upon the upper surfaces of upper stringers and crosspieces 22, 26, respectively.

The upper wall of the bathtub has a lip 46 which contacts the outer walls of the upper stringers and crosspieces to prevent the bathtub from moving sideways or forward and backwards relative to the enclosure.

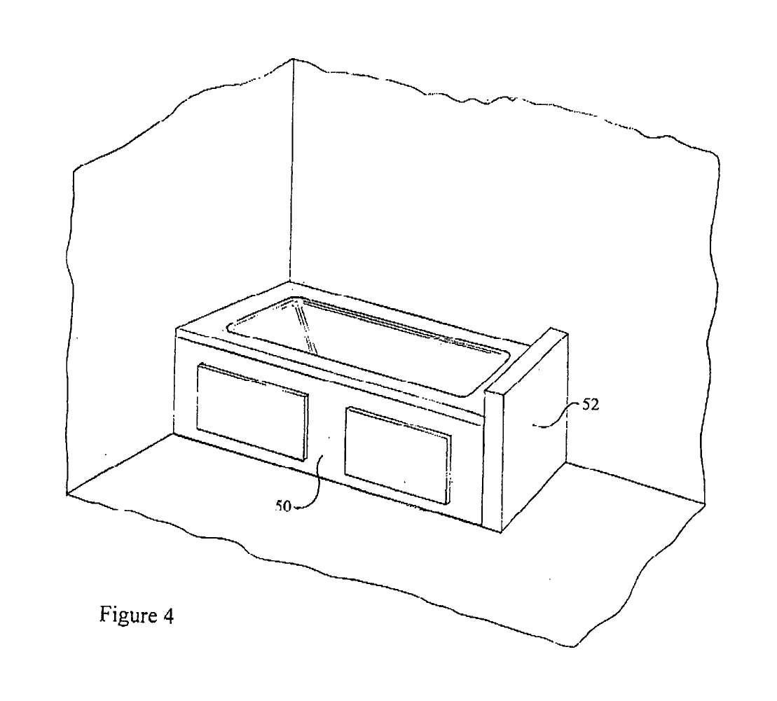

With reference to FIGS. 3 and 4, front and side panels 50, 52, respectively, are attached to the stringers and the crosspieces at the front and one end of the enclosure to conceal the interior from its exposed areas. The hardware for the bathtub such as controls, mechanical motors, pipes and jets is located within the enclosure and is installed at the factory contemporaneously with the construction of the enclosure. After the enclosure is installed, the hardware can be accessed by removing one or the other panel should repairs be needed to it.

The under or bottom surfaces of the lower stringers and cross members all lie in the same imaginary plane so that the enclosure, when it rests on a level or horizontal floor rests solidly and does not rock. The upper surfaces of the upper stringers and crosspieces should be parallel with the under surfaces of the lower stringers and crosspieces so that the upper wall of the bathtub will be horizontal when the bottom wall is horizontal. The bathtub will accordingly be supported in a position required for it to function properly. This is particularly important where the bathtub has a number of nozzles for spraying water into the tub in order to create a so-called whirlpool effect.

As previously indicated, the hardware for the bathtub are installed within the enclosure at the time of construction of the enclosure at a factory. The enclosure protects the hardware after installation, during shipping and while the enclosure is being installed at its permanent location. The hardware is accessible from the side or ends of the enclosure should repairs be needed after the enclosure is installed at its permanent location.

The bathtub is permanently affixed to the enclosure at a factory or other location remote from the site where the bathtub is to be permanently located. The orientation of the bathtub in the enclosure is such that it functions properly in use. Installation, apart from hooking the hardware to sources of hot and cold water, and if necessary, to a source of electricity, only involves levelling the enclosure so that its under or bottom surfaces of the lower stringers and crosspieces are horizontal.

The components of the enclosure may be formed of wood such as fir or spruce or they may be formed of aluminum, steel or other metal. The material may be coated with a non-toxic moisture block to protect it during use. When the enclosure is ready to be discarded, the entire structure can be composted.

In summary the enclosure is constructed, in accordance with the method of the invention, at a factory where equipment such as power saws, presses, staple guns and the like are available to accelerate the pace of assembly. The bathtub is also position in the enclosure at the factory where equipment for raising it and lowering it into the enclosure is available.

It will be understood, of course, that modifications can be made in the steps of the process of the invention without departing from the scope and purview of the invention as defined in the appended claims.

We claim:

1. A method of preparation of a bathtub and an enclosure for said bathtub for shipping including the following steps: (1) providing at a factory or other location remote from a site where said bathtub is to be permanently installed materials which will form the components of said enclosure for said bathtub; (2) forming from the materials at said factory or other said remote location said enclosure having end and side walls and a bottom surface which contacts and exerts the weight of said enclosure and bathtub on a floor or other surface; (3) placing at said factory or other said remote location said bathtub in said enclosure; (4) permanently affixing at said factory or other said remote location said bathtub to said enclosure; and (5) shipping said bathtub and enclosure of step 4 from said factory or other said remote location.

2. A method of preparation of a bathtub and an enclosure for said bathtub for shipping including the following steps: (1) providing at a factory or other location remote from a site where said bathtub is to be permanently installed materials which will form the components of said enclosure for said bathtub; (2) forming from the materials at said factory or other said remote location said enclosure having end and side wails and a bottom surface which contacts and exerts the weight of said enclosure and bathtub on a floor or other surface; (3) taking appropriate steps at said factory or other said remote location to ensure that said bottom surface is adapted to rest solidly on a level surface and does not to rock; (4) placing at said factory or other said remote location said bathtub in said enclosure; (5) permanently affixing at said factory or other said remote location said bathtub to said enclosure such that said bathtub is oriented in a position required to function properly when said bottom surface is level; and (6) shipping said bathtub and enclosure of step 5 from said factory or other said remote location.

3. The method of claim 2 further including the step of (5a) installing at said factory or other said remote location permanently within said enclosure hardware including pipes and jets required for said bathtub to function prior to carrying out step 6.
